(19) United States
(12) Patent Application Publication
(10) Pub. No.: US 2007/0026752 A1
(43) Pub. Date: Feb. 1, 2007

(54) Textile surface which can be used to produce protective clothing, in particular, for fire fighters, and multilayer complexes comprising said surface

(76) Inventor: Laurent Thiriot, Andolsheim (FR)

Correspondence Address: KENYON & KENYON LLP, 1500 K STREET N.W., SUITE 700, WASHINGTON, DC, 20005, US

(21) Appl. No.: 10/555,606

(22) PCT Filed: May 6, 2004
(86) PCT No.: PCT/FR04/01103

§ 371 Date: Apr. 11, 2006

(30) Foreign Application Priority Data
May 6, 2003 (FR) 03/05486

(51) Int. Cl. B32B 5/22; B32B 27/12; D03D 15/00

(52) U.S. Cl. 442/217; 442/304; 442/208; 442/209; 442/312; 442/76; 442/86; 442/218; 442/286

(57) ABSTRACT

The present invention relates to a textile surface for thermal insulation, in particular for making protective garments, in particular garments for protecting firefighters, the textile surface presenting a thermal barrier function and comprising threads of type A that are temperature-stable and presenting little or no shrinkage under the effect of high temperature, and threads of type B that shrink under the effect of high temperature; the threads of type B enable controlled relief to be created, thereby increasing the insulating power of textile multilayer structures that are used for providing thermal protection. The invention also provides multilayer structures including said surface.

### TECHNICAL FIELD

The present invention relates to fabric, in sheet or web form, for use in making protective garments, in particular working jackets for people that are to be subjected to extreme conditions, in particular in the event of fire.

The invention relates in particular to a novel type of material suitable for making garments for firefighters, but without that excluding other applications.

Thus, the textile surface of the invention finds an application in all circumstances where extreme conditions are present, for example during a fire, and more generally for providing protection against a source of high temperature.

### PRIOR ART

the description below, the invention is described for a particular application, namely that of making working jackets for firefighters.

It is clear that the invention is not limited thereto and that such a material could be used in other applications, and in all circumstances where extreme conditions are present, for example during a fire.

At present, in order to make working jackets, multilayer structures are used which, in general and as can be seen in accompanying FIG. 1, are usually made up of four elements, namely:
an outer textile (A);
a breathing and waterproof membrane (B), generally associated with a support (B′);
a thermal barrier (C) generally constituted by a needled felt; and
a finishing lining (D).

The making of such multilayered materials suitable for use under extreme conditions is well known to the person skilled in the art and is described in particular in document FR-A-1 213 415.

Since then, such structures have progressed, in particular by making use of temperature- and fire-proof textile materials based on aromatic polyamide or on polyamide imide.

Amongst such synthetic materials that are the best known, mention can be made in particular of the family of aromatic polyamides or para-aramid threads and fibers, such as those sold by the supplier Dupont de Nemours under the name “KEVLAR” or the supplier Teijin under the trademarks “TWARON” and “TECHNORA”. Such polymers, which can thus be in the form of fibers, threads, or other structures, constitute the subject matter of numerous publications, and document US 3 063 966 can be mentioned in particular.

Amongst materials that also withstand high temperatures, and that form part of the meta-aramid family, mention can be made of the polymer sold by the supplier Kermel under its own name, fibers sold by Dupont de Nemours under the trademark “NOMEX”, and those sold by Teijin under the trademark “CONEX”.

As mentioned above, the invention thus relates to the sector of making multilayer materials of the kind shown in FIG. 1.

In such materials, a problem arises concerning the thermal barrier, which is generally constituted by a needled felt.

The multilayer structures that have been proposed in the past present a drawback that lies essentially in the fact that garments made out of them are uncomfortable both physically and physiologically.

In addition, under certain conditions, they are lacking in effectiveness.

It has been reported that about 50% of the causes of death for firefighters in action in the United States are the consequence of a phenomenon that is well known in the field under the term “heat stress” which is a state in which the body can no longer maintain a temperature below 39° C. and which leads to a variety of troubles that can not only lead to a loss of physical capacity, but that can also include a loss of lucidity, fainting, or indeed cardiac arrest.

Such a state of stress is caused in particular by the weight of the equipment used, that can exceed 20 kilograms (kg), and also by the protective clothing sometimes presenting a capacity for insulation that is too great.

### SUMMARY OF THE INVENTION

It has been discovered, and this constitutes the subject matter of the present invention, that it is possible to solve this problem by making a novel type of material presenting a thermal barrier of function that vary over time, thus enabling novel multilayered structures to be made that present a good compromise between comfort and protection.

This novel type of material provides moderate insulation under normal circumstances because it presents small thickness and a small thermal load, thereby improving comfort, but with increasing temperature it enables increasing insulation to be obtained, with said increase being localized in zones where the temperature is highest when the user is confronted with an emergency situation in the presence of a fire.

In general, and given the problem posed of achieving a thermal barrier for providing protection, in particular in garments for firefighters, while also seeking to improve the comfort of said garments both physically and physiologically, the invention provides a textile surface presenting a thermal barrier function comprising threads of type A that are temperature-stable, presenting little or no shrinkage under the effect of high temperature, and threads or groups of threads of type B that present shrinkage under the effect of high temperature, the textile surface being characterized in that the threads and/or groups of threads of type B are distributed in at least one direction of the structure and are separated at least in part by threads of type A in such a manner that the surface forms cells in relief under the effects of high temperature and of the preferential shrinking of the threads and/or groups of threads of type B.

The invention also provides multilayer structures for use in particular in making protective garments, and comprising the above-described textile surface.

The term “thread” is used to cover a continuous or a spun multifilament object obtained from a single type of fiber or from a mixture of fibers. It can also cover an assembly of continuous threads or of spun fibers.

The term “group” of threads is used to cover a set of threads disposed contiguously in a given direction of the surface of the invention. For example, when the textile surface is a woven surface, a group of threads may be a set comprising a plurality of threads disposed side by side in the warp direction and/or in the weft direction of the woven surface.

The term “threads of type B” covers threads or groups of threads of type B.

In the invention, the groups of threads of type B preferably comprise 2 to 10 threads of type B.

The distribution of threads of type B over the surface of the invention may be regular or irregular, in a given direction of the surface.

In a particular embodiment of the surface of the invention, the distribution of threads of type B in at least one direction of the surface is regular. For example, in a given direction of the surface, e.g. in the warp direction of a woven surface, the warp threads of type B are disposed at regular intervals relative to one another.

The textile surface of the invention is advantageously a woven surface or a knitted surface, and is preferably a woven surface.

When the textile surface of the invention is a woven surface or a knitted surface, the threads of type B are warp threads and/or weft threads. They are distributed in the machine direction and/or in the cross-direction of the surface. They may be present in the machine direction only, or in the cross-direction only.

At least some of the threads of type B are separated from one another by some number of threads of type A. Preferably, the threads of type B and/or the groups of threads of type B are separated by a number of threads of type A lying in the range 3 to 30. For example, when the surface of the invention is a woven surface, each warp thread of type B may be separated by 10 to 15 warp threads of type A. The number chosen depends in particular on the fineness of the threads used and on the intrinsic shrinkage force of the threads of type B.

The term “threads of type A” is used to mean threads that are temperature-stable, that present little or no shrinkage under the effect of high temperature, and in any event present shrinkage that is much less than that of threads of type B.

The threads of type A of the invention are temperature-stable. They are threads or fibers in which, after being exposed to intense heat, loss of mechanical properties and above all shrinkage are limited. The temperature-stable threads may be made of natural or artificial synthetic material, or of a mixture.

The threads of type A are preferably threads of the para-aramid or polyparaphenylene-2,6-benzobisoxazole (PBO) type. In this context, mention can be made of threads of type A that are threads of polyparaphenylene terephthalamide (“KELVAR” from Dupont, “TWARON” and “TECHNORA” from Teijin).

The threads of type B preferably present a certain amount of temperature stability in that they conserve some degree of mechanical strength, while nevertheless presenting greater shrinkage under the effect of high temperature. The threads of type B are preferably threads of the meta-aramid type. Examples of threads of type B include threads of polymetaphenylene isophthalamide, threads of polyamide imide, and threads known under the trademark “KERMEL” (Kermel), or “NOMEX” (Dupont), or “CONEX” (Teijin). The nature of the threads of type B may be selected in particular as a function of the desired shrinkage force.

The threads of type A and/or of type B may be constituted by mixtures of fibers and/or filaments, which mixtures may be intimate mixtures or mixtures of the core/skin type (spun yarns using cored fibers). The fibers of the filament of the mixture may include fibers or filaments of a kind that are different from a given type. For example, the threads of type A may be constituted completely or in part of different temperature-stable fibers or filaments.

The surface of the invention may be constituted solely by threads of type A and of type B, however it may also include other types of thread or fiber.

The surface of the invention advantageously includes at least 20% by weight threads of type A, and preferably at least 60% by weight.

When the surface of the invention is woven, the threads of type B and the threads of type A may be woven differently from each other: for example the threads of type B may be woven using a weave that presents floats that are greater than the floats of the threads of type A. This makes it possible in particular to obtain good flexibility for the surface, and also to increase the capacity of the threads of type B to slide on shrinking, because these threads are held in the surface to a lesser extent.

In a particular embodiment of the surface of the invention, the threads of type B and/or the groups of threads of type B form checkerwork. For example, for a woven surface, the set of threads of type B, both warp threads and weft threads, may define contiguous squares or rectangles over the entire surface. Under the action of high temperature and the shrinkage of the threads of type B, it is these squares or rectangles that constitute the cells in relief on the textile surface of the invention.

In another particular embodiment of the surface of the invention, the threads of type B and/or the groups of threads of type B are disposed in a single direction of the surface of the invention. Under such circumstances, under the action of high temperature and the shrinking of the threads of type B, each portion of the surface between the threads of type B or groups of threads of type B becomes deformed in relief, which deformation may be constituted, for example, by alternating zones that project and zones that are recessed, this alternation balancing over two adjacent surface portions.

Thus, the textile surface of the invention forms cells in relief under the effect of high temperature. The term “cell” covers a portion of the surface of the invention generally comprising threads of type A, and not comprising threads of type B, with edges that are formed by threads of type B and/or by an edge of the surface of the invention. For example, when the threads of type B form checkerwork in the woven surface the cells are squares defined by threads of type B and by the edges of the cloth.

The cells may be of varying sizes. In particular, cell size may be selected as a function of the increase in thickness desired for the surface under the effect of heat. This increase in thickness, which corresponds to a change in the thickness of the surface due to the formation of cells in relief, should be at least 0.5 millimeters (mm), and should preferably lie in the range 1 mm to 3 mm. Even a very small change in thickness can be advantageous, in particular when the textile surface of the invention is integrated in a multilayer structure, since this increase creates a layer of air which, even when very thin, increases the insulating characteristics of the multilayer structure.

In theory, cells of large size enable the increase in thickness to be greater and thus enable greater thermal insulation to be achieved. However, when using cells of large size, it is preferable to select a weaving structure that is close in order to provide the cells in relief with better ability to withstand being flattened.

The structure of the surface of the invention may also vary. In particular, it may be selected as a function of the size of the cells, as described above. The structure should be selected appropriately, in particular to ensure that the cells in relief formed under the effect of high temperature present good ability to withstand being flattened. Cells occupying about 5 mm between two threads or groups of threads of type B generally present satisfactory ability to withstand flattening, regardless of the structure.

The surface of the invention may be obtained by weaving or knitting using a method known to the person skilled in the art, while appropriately selecting the nature of each thread and its position in the surface. For example, for a woven surface, each warp thread and each weft thread should be selected as a function of the final configuration desired for the surface. Knitting is advantageously performed using a warp knitting machine with a weft magazine; under such circumstances, it is the threads of type B that are introduced in the weft.

The present invention also provides a multilayer structure for use in particular in making protective garments, and including the above-described textile surface.

The present invention thus provides a multilayer structure for protective garments, the multilayer structure comprising:
an outer textile;
a breathing and waterproof membrane optionally associated with a support;
a textile surface as described above;
optionally a thermal barrier (C); and
optionally a finishing lining (D).

In such multilayer structures, the nature of the threads of type B in the textile surface of the invention is selected in particular as a function of the position of the textile surface in the multilayer structure (how close it is to the outside). It is preferable to select a thread of a nature that presents shrinkage at a relatively high temperature when the textile surface of the invention is close to the outside, and the nature of the thread should present shrinkage at a lower temperature when the textile surface of the invention is closer to the inside. Ideally, the nature of the threads of type B is selected so that total shrinkage of the threads of type B takes place after enough time has elapsed to reach the pain threshold when the person is exposed to heat flux (i.e. a warning threshold), and before enough time has elapsed for burns to appear. This makes it possible to increase the “escape time” that a firefighter's protective garment needs to be able to make available.

The membrane is preferably positioned between the outer textile and the textile surface of the invention.

The outer textile is made of fireproofed material. It serves to form a face or a wall that does not come into contact with the user. For example, the fireproof textile is preferably constituted by cloth based on metaphenylene isophthalamide or polyamide-imide threads, possibly together with polyparaphenylene terephthalamide threads, and/or antistatic threads or other para-aramid threads or threads of PBO or polybenzimadazole (PBI) type.

The membrane may be constituted by a microporous or hydrophilic film, e.g. based on polytetrafluoroethylene, fireproofed polyurethane, or polyester.

The optional support for the membrane may be a textile support, such as a woven or non-woven fabric based on meta-aramid fibers or on polyamide-imide fibers, e.g. associated with membrane by laminating.

In a first particular embodiment of the multilayer structure of the invention, the multilayer structure comprises:
an outer textile;
a breathing and waterproof membrane optionally associated with a support;
a textile surface as described above; and
a finishing lining (D).

In this embodiment, the textile surface of the invention then acts as a thermal barrier, replacing the traditional needled felt. Under such circumstances, the nature of the threads of type B in the textile surface of the invention is selected so that they shrink at temperatures that are relatively low. This embodiment is shown in particular in Example 4 and FIG. 6.

In a second particular embodiment of the multilayer structure of the invention, the multilayer structure comprises:
an outer textile;
a textile surface as described above;
a breathing and waterproof membrane;
optionally a thermal barrier (C); and
a finishing lining (D)
   and the textile surface of the invention is laminated to the membrane.

Lamination is performed using any method known to the person skilled in the art. In this embodiment, the textile surface of the invention is preferably positioned between the membrane and the outer textile. It thus provides both a thermal barrier and also mechanical protection for the membrane, e.g. providing the membrane with the ability to withstand being cut, given that the membrane is the fragile element of the multilayer structure as a whole. The textile surface of the invention preferably includes threads that present very good mechanical strength properties, preferably of the para-aramid or PBO type. This embodiment is illustrated in particular by Example 3 and FIG. 5.

In a third particular embodiment of the multilayer structure of the invention, the multilayer structure comprises:
an outer textile;
a breathing and waterproof membrane;
a textile surface as described above;
optionally a thermal barrier (C); and
a finishing lining (D)
   with the textile surface being laminated to the membrane and the membrane being laminated to the outer textile.

The disposition of the layers in the multilayer structure, from the outside towards the inside of the garment is thus as follows: the laminated assembly formed by the outer textile; the breathing and waterproof membrane; the textile surface of the invention; optionally followed by a thermal barrier (C); and finally by the finishing lining (D).

Lamination is implemented by any method known to the person skilled in the art. In this embodiment, the surface of the invention acts simultaneously as a thermal barrier, as mechanical reinforcement for the membrane, and for the outer textile due to the threads that are preferably of the para-aramid or PBO type in the surface of the invention. It also provides the multilayer structure as a whole with the ability to provide good resistance to heat. In this embodiment, the threads of type B of the textile surface of the invention are preferably threads presenting strong shrinkage force and/or the surface includes a large percentage by weight of such threads. This embodiment is shown in particular by Example 2 and FIGS. 3 and 4.

The laminated assembly (outer textile; breathing and waterproof membrane; textile surface of the invention) in this third particular embodiment as described above can be used as the outer layer used for making up multilayer structures of the kind shown in FIG. 1. This outer layer presents a thermal barrier function, it is highly temperature-stable and presents great resistance to high temperatures, in particular because of the presence of threads that are preferably of the para-aramid or the PBO type in the surface of the invention; it ages very well, in particular in terms of appearance. Concerning this additional advantage of aging well, an outer textile of an emergency working garment is generally made up of mixtures containing fibers of the para-aramid type that present problems of becoming unsightly on being washed and of losing strength after being exposed to UV radiation. In the above-described type of laminated assembly, the outer textile can omit such materials because of the reinforcement provided by the para-aramid type threads in the surface of the invention, and can as a result constitute a textile that is merely “decorative”.

This means that the outer textile can present good aging characteristics in terms of appearance since it does not contain threads of the para-aramid type; and the threads of the para-aramid type that are present in the surface of the invention are thus sheltered from light and therefore do not lose their strength properties over time.

The surface of the invention and the multilayer structures of the invention as described above find a particularly advantageous application in making garments that provide protection against the risk associated with fire, e.g. a firefighter's jacket.

### BRIEF DESCRIPTION OF THE DRAWINGS

The invention and the advantages it provides can be better understood from the following examples of textile surfaces and multilayer structures in accordance with the invention that are illustrated in the accompanying diagrams, in which:

FIG. 1, as described above, shows a conventional multilayer structure as used in the past for making garments for people acting under risky conditions, in particular firefighters garments;

FIG. 2 shows a weave for cloth in accordance with the invention;

FIG. 3 is a diagrammatic view of a multilayer structure constituting the third particular embodiment of the invention;

FIG. 4 is a diagrammatic perspective view showing how a multilayer structure of the third particular embodiment of the invention changes when the user is confronted with a sudden change in operating conditions, and more particularly a sudden increase in temperature;

FIG. 5 is a diagrammatic view of a multilayer structure constituting a second particular embodiment of the invention; and

FIG. 6 is a diagrammatic view of a multilayer structure constituting a first particular embodiment of the invention.

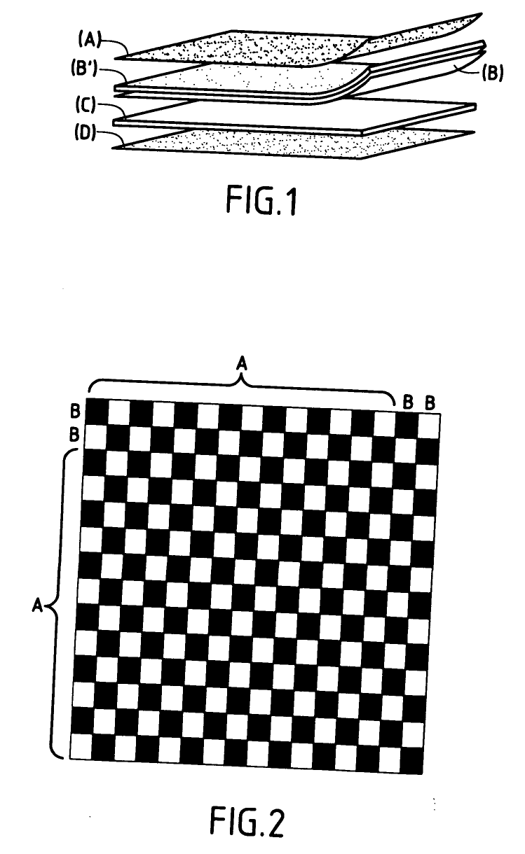

### EXAMPLES

### Example 1

A Cloth of the Invention Comprising Para-aramid Threads and Polyamide-imide Threads

A cloth was made in accordance with the invention using a weave as shown in FIG. 2.

The threads of type A were para-aramid threads (100% cracked Twaron®, thread size being equal to Nm 80/2).

The threads of type B were polyamide-imide threads (Kermel Tech® 100%, the size of the threads being equal to Nm 70/2).

The structure of the cloth was as follows: warp, 27 threads/cm; weft, 22 picks/cm.

The weave was of the plain type with warp alternation of 14 threads of type A and 2 threads of type B, and weft alternation of 12 threads of type A and 2 threads of type B.

The weight per unit area of this cloth was about 130 grams per square centimeter (g/cm²).

### Example 2

Multilayer Structure Including the Cloth of Example 1

A multilayer structure was built up from a laminated assembly EL1 comprising three laminated layers as described below together with finishing lining of type (D) as described below.

Laminated assembly EL1:
layer 1: outer textile: cloth comprising Kermel® and antistatic fiber R-Stat® at 98/2 by weight; weight per unit area 145 g/m²; weaving structure 26×22 threads/cm; size Nm 68/2;
layer 2: hydrophilic polyurethane membrane; and
layer 3: the cloth described in Example 1.

Finishing lining of type (D): Kermel® and viscose FR® twill sold by the supplier Lensing at 70/30 by weight; weight per unit area 130 g/m²; weaving structure 42×30 threads/cm; size Nm 60/1.

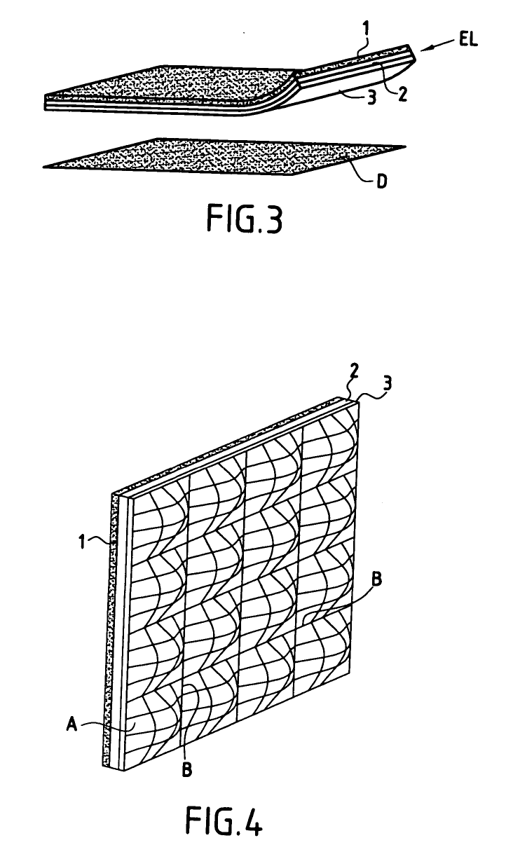

FIG. 3 is a diagrammatic view of the multilayer structure: from top to bottom in the laminated assembly EL1 there can be seen the layer 1, the layer 2, and then the layer 3.

FIG. 4 is a diagrammatic perspective view showing how the multilayer structure including the cloth of the invention (reactive support) changes when the user is confronted with a sudden change in operating conditions, and in particular a sudden increase in temperature. The outer cloth in FIG. 4 corresponds to the layer 1, the membrane in FIG. 4 corresponds to the layer 2. When the threads of type B (forming checkerwork in FIG. 4) are subjected to the effect of high temperature, the edges of the cells they form move towards one another, while the temperature has little or no effect on the threads of type A forming the insides of the cells. This causes blisters to form in relief: the insulating capacity of the structure is thus increased by trapping air, in the event of a thermal risk being present, e.g. due to a sudden increase in temperature.

It should be observed that the ability of threads of type B to shrink is not opposed by bonding to the membrane, since at the temperature at which this reaction occurs, the membrane has already begun to disintegrate.

### Example 3

Multilayer Structure Including the Cloth of Example 1

A multilayer structure was made up of an outer textile A, a laminated assembly EL2 consisting in two laminated layers, and a finishing lining of type (D), these elements being of the kinds described above.

Outer textile=rip-stop Kermel HTA® cloth (64% Kermel®, 35% Technora®, 1% stainless steel antistatic fiber, percentages by weight); weight per unit area 205 g/m²; weaving structure 22×22 threads/cm; size Nm 45/2.

Laminated assembly EL2:

layer 1: cloth described in Example 1; and

layer 2: expanded PTFE membrane Laminated to the layer 1.

Finishing lining of type (D): Kermel® and viscose FR® twill sold by the supplier Lensing, 70/30 by weight; weight per unit area 130 g/m²; weaving structure 42×30 threads/cm; size Nm 60/1.

FIG. 5 is a diagrammatic view of the multilayer structure: from top to bottom in system B there are shown the layer 1 followed by the layer 2.

### Example 4

Multilayer Structure Including the Cloth of Example 1

A multilayer structure was made up from an outer textile A, a membrane B associated with a support, a cloth C in accordance with the invention, and a finishing lining D of type (D), these elements being described below.

Outer textile: Kermel HTA® and antistatic fiber rip-stop satin at 98/2 by weight; weight per unit area 245 g/m²; weaving structure 36×32 threads/cm; size Nm 60/2.

Hydrophilic polyurethane membrane laminated on a support: non-woven Kermel® and Twaron® fabric at 65/35 by weight; weight per unit area 95 c/m².

Cloth as described in Example 1.

Finishing lining of type (D): Kermel® and viscose FR® cloth lining sold by the supplier Lensing, at 50/50 by weight; weight per unit area 115 g/m²; weaving structure 30×30 threads/cm; size Nm 45/1.

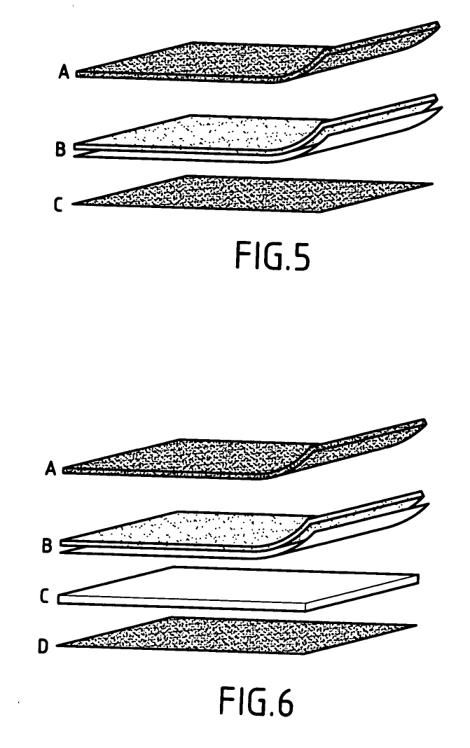

FIG. 6 is a diagrammatic view of the multilayer structure.

The present invention is not limited to the embodiments described above by way of non-exhaustive examples.

For the textile surface in woven form, the weave may be of the twill type, in particular when it is desired to form floats, e.g. floats of 3 with threads of type B.

For a textile surface of knitted type, the configuration of knitted stitches is not very favorable to the desired effect concerning the threads of type B, insofar as shrinkage of these threads will lead in part to deformation of the stitches themselves. It is therefore desirable for the threads of type B to be as nearly rectilinear as possible, in particular in the form of weft inserted in the columns of the stitches of the knit.

When the textile surface of the invention is implemented in a three-layer laminate with a breathing and waterproof membrane laminated between said surface and an outer textile, this raises the problem of making stitches leaktight when sewing the garments. Such leaktightness is usually achieved by applying adhesive and a sealing membrane along the stitching on the inside face. To enable the adhesive to penetrate through the textile surface of the invention it is necessary to create sufficient porosity in said surface, at the stitches, to enable such penetration to be obtained.

1. A textile surface for thermal insulation, in particular for making protective garments, the surface presenting a thermal barrier function and comprising threads of type A that are temperature-stable presenting little or no shrinkage under the effect of high temperature, and threads and/or groups of threads of type B that shrink under the effect of high temperature, the textile surface being characterized in that the threads and/or groups of threads of type B are distributed in at least one direction of the structure and are separated at least in part by threads of type A in such a manner that the surface forms cells in relief under the effects of high temperature and of the preferential shrinking of the threads and/or groups of threads of type B.

2. A textile surface according to claim 1, wherein the textile surface is woven with a plain weave or a twill weave.

3. A textile surface according to claim 1 wherein the threads of type B form floats, e.g. floats of 3.

4. A textile surface according to claim 1, wherein said textile surface is knitted on a warp knitting machine with a weft magazine, and in that the threads of type B are weft threads.

5. A textile surface according to claim 1, wherein the threads of type A are threads of para-aramid type or PBO type.

6. A textile surface according to claim 1, wherein the threads of type B are threads of meta-aramid type.

7. A textile surface according to claim 1, wherein said textile surface comprises at least 20% by weight of threads of type A, preferably at least 60% by weight of threads of type A.

8. A textile surface according to claim 1, wherein the groups of threads of type B comprise 2 to 10 threads of type B.

9. A textile surface according to claim 1, wherein the threads of type B and/or the groups of threads of type B are separated by a number of threads of type A lying in the range 3 to 30, preferably in the range 10 to 15.

10. A textile surface according to claim 1, wherein the distribution of threads of type B and/or of groups of threads of type B in at least one direction of the surface is regular, the threads or groups preferably being spaced apart by about 5 mm.

11. A textile surface according to claim 1, wherein the threads of type B and/or the groups of threads of type B form checkerwork, e.g., in squares or in rectangles.

12. A textile surface according claim 1, wherein the threads of type B and/or groups of threads of type B are disposed in a single direction.

13. A textile surface according claim 1, wherein, under the effect of temperature, the cells develop in relief over at least 0.5 mm, preferably over 1 mm to 3 mm.

14. A multilayer structure for a protective garment, the multilayer structures comprising:
an outer textile;
a breathing and/or waterproof membrane optionally associated with a support;
a textile surface according to claim 1;
optionally a thermal barrier (C); and
optionally a finishing lining (D).

15. A multilayer structure according to claim 14, wherein the breathing and/or waterproof membrane is positioned between the outer textile and the textile surface.

16. A multilayer structure according to claim 14, comprising:
an outer textile;
a textile surface for thermal insulation, in particular for making protective garments, the surface presenting a thermal barrier function and comprising threads of type A that are temperature-stable presenting little or no shrinkage under the effect of high temperature, and threads and/or groups of threads of type B that shrink under the effect of high temperature, the textile surface being characterized in that the threads and/or groups of threads of type B are distributed in at least one direction of the structure and are separated at least in part by threads of type A in such a manner that the surface forms cells in relief under the effects of high temperature and of the preferential shrinking of the threads and/or groups of threads of type B;
a breathing and waterproof membrane;
optionally a thermal barrier (C); and
a finishing lining (D)
wherein the textile surface is laminated to the membrane.

17. A multilayer structure according to claim 16, wherein the textile surface is positioned between the membrane and the outer textile.

18. A multilayer structure according to claim 14 comprising:
an outer textile;
a breathing and waterproof membrane;
a textile surface for thermal insulation, in particular for making protective garments, the surface presenting a thermal barrier function and comprising threads of type A that are temperature-stable presenting little or no shrinkage under the effect of high temperature, and threads and/or groups of threads of type B that shrink under the effect of high temperature, the textile surface being characterized in that the threads and/or groups of threads of type B are distributed in at least one direction of the structure and are separated at least in part by threads of type A in such a manner that the surface forms cells in relief under the effects of high temperature and of the preferential shrinking of the threads and/or groups of threads of type B;
optionally a thermal barrier (C); and
a finishing lining (D),
wherein the textile surface is laminated to the membrane and the membrane is laminated to the outer textile; and
wherein the disposition of the layers in the multilayer structure from the outside towards the inside of the garment is as follows: outer textile; breathing and waterproof membrane; textile surface; optionally thermal barrier (C); and finishing lining (D).

19. A protective garment, in particular for firefighters, of the multilayer structure according to claim 18 used as an outer layer.

20. (canceled)

21. A protective garment for firefighters having a textile surface for thermal insulation, in particular for making protective garments, the surface presenting a thermal barrier function and comprising threads of type A that are temperature-stable presenting little or no shrinkage under the effect of high temperature; and threads and/or groups of threads of type B that shrink, under the effect of high temperature, the textile surface being characterized in that the threads and/or groups of threads of type B are distributed in at least one direction of the structure and are separated at least in part by threads of type A in such a manner that the surface forms cells in relief under the effects of high temperature and of the preferential shrinking of the threads and/or groups of threads of type B.

22. A protective garment for firefighters having a multilayer structure comprising:
an outer textile;
a breathing and/or waterproof membrane optionally associated with a support;
a textile surface according to claim 1;
optionally a thermal barrier (C); and
optionally a finishing lining (D).
